(19) United States
(12) Patent Application Publication
(10) Pub. No.: US 2020/0036823 A1
(43) Pub. Date: Jan. 30, 2020

(54) MOBILE TERMINAL AND IMAGING METHOD THEREOF

(71) Applicant: BOE TECHNOLOGY GROUP CO., LTD., Beijing (CN)

(72) Inventors: Mingche HSIEH, Beijing (CN); Shanchen KAO, Beijing (CN); Haijun QIU, Beijing (CN)

(21) Appl. No.: 16/337,766

(22) PCT Filed: Jul. 27, 2018
(86) PCT No.: PCT/CN2018/097474

§ 371 Date: Mar. 28, 2019

(30) Foreign Application Priority Data
Aug. 7, 2017 (CN) 201710666109.2

(51) Int. Cl. H04M 1/02; H04N 5/225; H04N 5/232

(52) U.S. Cl. CPC H04M 1/0266; H04N 5/23232; H04N 5/2257; H04M 1/0264

(57) ABSTRACT

A mobile terminal is provided and includes a display panel, a processor, a controller and at least two image collectors located at a side of the display panel distal to a side of a light outgoing surface of the display panel; the at least two image collectors are configured to acquire images of a same scene at the side of the light outgoing surface of the display panel so as to obtain at least two preview images; the processor is configured to synthesize the acquired at least two preview images into a target image such that a sharpness of the target image is higher than a sharpness of each of the preview images; and the controller is configured to send the target image to the display panel for display.

### CROSS-REFERENCE TO RELATED APPLICATIONS

This is a National Phase Application filed under 35 U.S.C. 371 as a national stage of PCT/CN2018/097474, filed on Jul. 27, 2018, an application which claims priority from Chinses Patent Application No. 201710666109.2 filed on Aug. 7, 2017, the disclosure of each of which is incorporated herein by reference in its entirety.

### TECHNICAL FIELD

The present disclosure relates to the field of display technology, and in particular to a mobile terminal and an imaging method thereof.

### BACKGROUND

Currently, the camera function of the mobile terminal is one of the most commonly used functions. In order to take photos, it is necessary to reserve a position for accommodating the camera on the mobile terminal. The camera is usually disposed in the peripheral area of the mobile terminal, which reduces the effective display area of the mobile terminal.

In order to solve the problem that the camera affects the effective display area of the mobile terminal, the camera can be set on the back surface of the mobile terminal far from the display surface so that the camera does not occupy the effective display area of the display panel. However, the camera is required to perform shooting through the pixel structure on the display panel. Therefore, the images captured by the camera are disturbed by the pixel structure on the display panel, causing the captured images to be blurred.

### SUMMARY

The present disclosure provides a mobile terminal which includes a display panel, a processor, a controller and at least two image collectors located in the display panel and at a side of the display panel distal to a light outgoing surface of the display panel; the at least two image collectors are configured to acquire images of a same scene at a side of the light outgoing surface of the display panel, respectively, so as to obtain at least two preview images; the processor is configured to synthesize the acquired at least two preview images into a target image such that a sharpness of the target image is higher than a sharpness of each of the at least two preview images; and the controller is configured to send the target image to the display panel for display.

Optionally, the processor includes a comparer and a synthesizer; the comparer is configured to compare intensities of high-frequency components for sub-pixels of the at least two preview images at respective same coordinate positions, and use sub-pixels, each of which has maximum intensity of high-frequency component at a corresponding coordinate position, as target sub-pixels; and the synthesizer is configured to synthesize the target sub-pixels to obtain the target image.

Optionally, the mobile terminal comprises two image collectors.

Optionally, the at least two image collectors acquire images simultaneously.

Optionally, a distance between the two image collectors is less than 20 mm

Optionally, each of the at least two image collectors comprises a camera.

Optionally, the at least two image collectors are located in a peripheral area in a display area of the display panel.

Optionally, the mobile terminal comprises any one of a mobile phone, a pad, and an electronic reader.

The present disclosure provides an imaging method of the above mobile terminal which includes: acquiring, by the at least two image collectors at the side of the display panel distal to the light outgoing surface of the display panel, images of a same scene at the side of the light outgoing surface of the display panel so as to obtain at least two preview images; synthesizing the acquired at least two preview images into a target image such that a sharpness of the target image is higher than a sharpness of each of the at least two preview images; and sending the target image to the display panel for display.

Optionally, the step of synthesizing the acquired at least two preview images into the target image includes: comparing intensities of high-frequency components for sub-pixels of the at least two preview images at respective same coordinate positions, and using sub-pixels, each of which has maximum intensity of high-frequency component at a corresponding coordinate position, as target sub-pixels; and synthesizing the target sub-pixels to obtain the target image.

Optionally, the at least two image collectors acquire images simultaneously.

### BRIEF DESCRIPTION OF THE FIGURES

FIG. 1 is a structural diagram of a mobile terminal according to an embodiment of the present disclosure;

FIG. 2 is a structural diagram of the mobile terminal according to an embodiment of the present disclosure;

FIG. 3 is a schematic diagram illustrating the image synthesis performed by the mobile terminal according to an embodiment of the present disclosure;

FIG. 4 is a schematic diagram illustrating the pixel selection performed by the mobile terminal according to an embodiment of the present disclosure;

FIG. 5 is a flow chart illustrating an imaging method of the mobile terminal according to an embodiment of the present disclosure; and

FIG. 6 is a schematic diagram illustrating a mobile phone which has two image collectors provided in the display area of a display panel at a side opposite to a light outgoing side of the display area, according to an embodiment of the present disclosure.

### DETAILED DESCRIPTION

In the display area of the display panel of the mobile terminal according to the present disclosure, at least two image collectors capable of acquiring an image of a same scene are provided at a side of the display panel distal to the light outgoing surface of the display panel. The at least two image collectors acquire at least two preview images. The processor synthesizes the acquired at least two images into a target image with a sharpness higher than the sharpness of each of the preview images. Therefore, the display panel of the mobile terminal in the present disclosure can display clearer images. Moreover, since the image collectors of the mobile terminal in the present disclosure are provided at a side distal to the light outgoing surface of the display panel, the mobile terminal can realize the bezel-less design.

The present disclosure will be further described in detail below in conjunction with specific implementations and the drawings in order that those skilled in the art can understand the technical solutions of the present disclosure better.

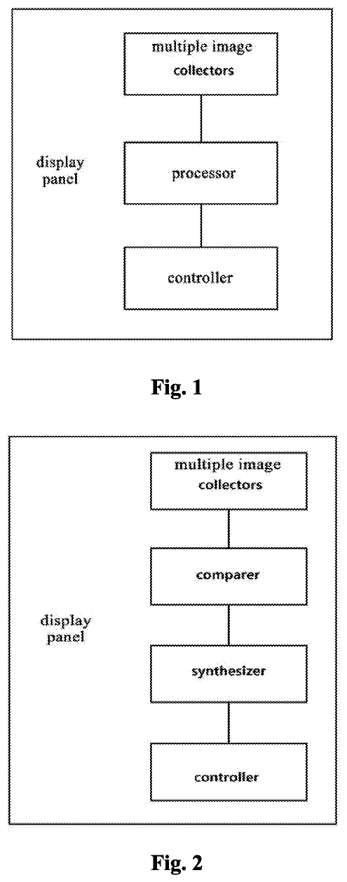

In an embodiment of the present disclosure, as shown in FIG. 1, the present embodiment provides a mobile terminal including a display panel, a processor, a controller and at least two image collectors located at a side of the display panel distal to a light outgoing surface of the display panel; the image collectors each are configured to acquire images of a same scene at the light outgoing surface side of the display panel, so as to obtain at least two preview images; the processor is configured to synthesize the acquired at least two preview images into a target image such that a sharpness of the target image is higher than a sharpness of any of the preview images; and the controller is configured to send the target image to the display panel for display.

As shown in FIG. 2, in the present embodiment, the processor in the mobile terminal may include a comparer and a synthesizer; the comparison element is configured to compare intensities of high-frequency components for sub-pixels of the preview images at respective same coordinate positions in order to obtain sub-pixels, each of which has maximum intensity of high-frequency component at a corresponding coordinate position, as target sub-pixels; and the synthesizer is configured to synthesize the target sub-pixels to obtain the target image such that the sharpness of the target image is higher than the sharpness of each the preview image.

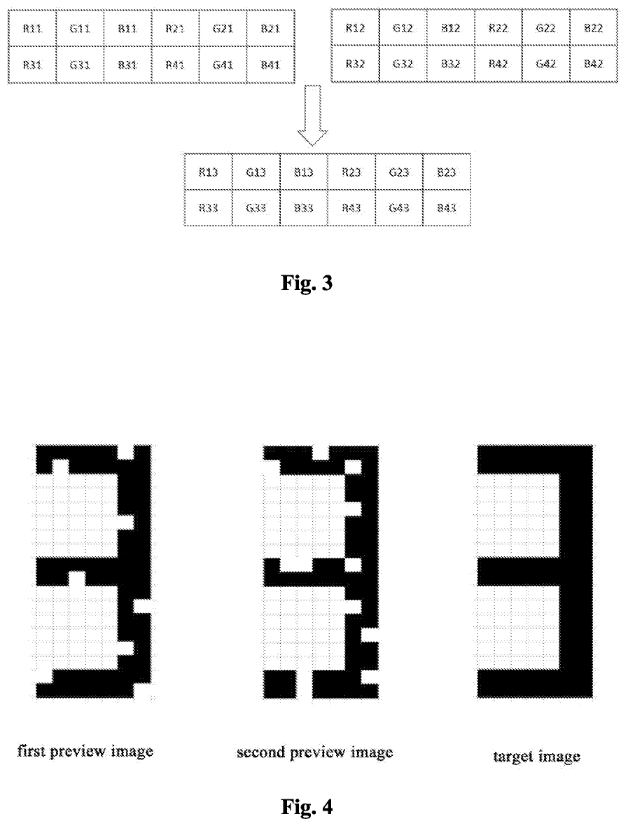

Specifically, two image collectors, i.e., a first image collector and a second image collector, are taken as an example for explanation from FIGS. 3 and 4. The first image collector and the second image collector acquire images for a same scene simultaneously. The image acquired by the first image collector is the first preview image, and the image acquired by the second image collector is the second preview image. The first and the second preview images have the same contents but different sharpness. The comparison element compares the intensity of high-frequency component for each sub-pixel in the first preview image with that for a sub-pixel in the second preview image at the same coordinate position, and use the sub-pixel having the maximum intensity of high-frequency component as a target sub-pixel. For instance, the sub-pixel R11 stand for that located in the first row and the first column in the first preview image, and the sub-pixel R12 stands for that located in the first row and the first column in the second preview image. Then, the intensity of high-frequency component for the sub-pixel R11 is compared with that for the sub-pixel R12. If the former is larger than the latter, the sub-pixel R11 is taken as the target sub-pixel R13; on the contrary, if the former is smaller than the latter, the sub-pixel R12 is taken as the target sub-pixel R13. In the same way, other target sub-pixels in the target image are also obtained. At last, all the target sub-pixels are synthesized by the synthesizer to obtain a target image, and the sharpness of the target image is higher than that of each of the preview images. In a case that there are more than two image collectors, the above method may also be used. That is, the comparison element compares the intensity of high-frequency component for each sub-pixel in each preview image with those for the sub-pixels in other preview images at the same coordinate position, respectively, in order to obtain the sub-pixel having the maximum intensity of high-frequency component as a target sub-pixel. At last, all the target sub-pixels are synthesized by the synthesizer to obtain the target image, and the sharpness of the target image is higher than that of each of the preview images.

In other cases, when there are two image collectors, the distance therebetween is less than 20 mm so that the two image collectors are guaranteed to acquire the same images (herein, the expression of “the same images” means the contents are same, does not mean the same sharpness), and thus the processor can obtain a clearer target image.

In the case, the image collectors in the present embodiment may be cameras or any other devices with image acquisition function.

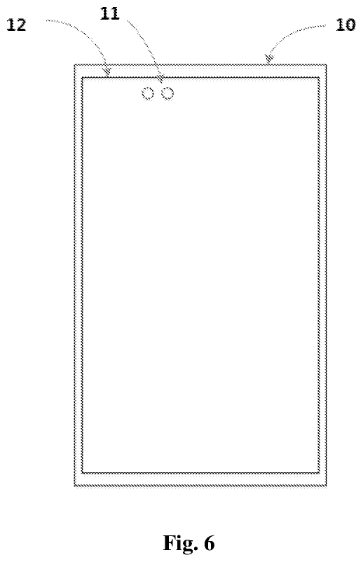

In the case, the image collectors in the present embodiment are located in the peripheral area in the display area of the display panel. Taking a mobile phone as an example, the image collectors may be located in the upper peripheral area (the side far away from the Home button) in the display area of the display panel of the mobile phone. For example, as shown in FIG. 6, a mobile phone 10 is provided with two image collectors 11, which are arranged at a side of the mobile phone 10 distal to a light outgoing surface of the mobile phone 10. That is, the two image collectors 11 are provided at a side opposite to a light outgoing side of the display area 12, but within the display area 12.

In the case, the mobile terminal in the present embodiment includes any one of a mobile phone, a pad, an electronic reader.

The controller in the mobile terminal may be additionally provided with, on the basis of the general controller, a function for sending the synthesized target image to the display panel for display according to the control program of the mobile terminal when needed.

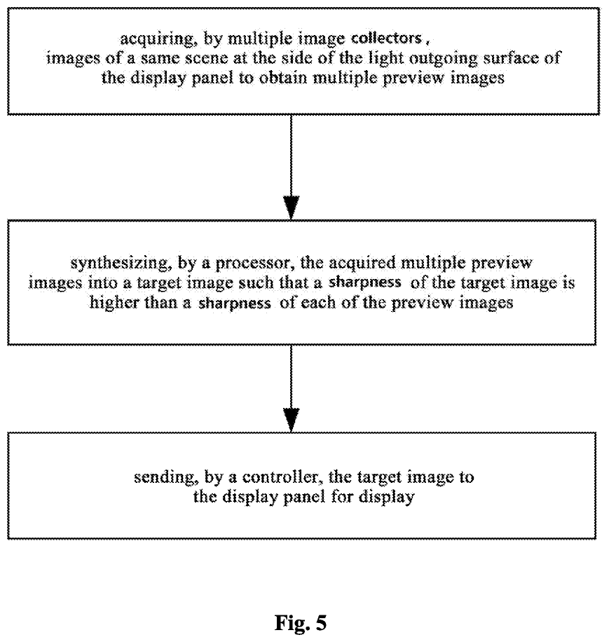

In an embodiment of the present disclosure, as shown in FIG. 5, the present embodiment provides an imaging method of a mobile terminal which may be the mobile terminal in the first embodiment. The imaging method particularly includes:

acquiring, by at least two image collectors at a side of the display panel distal to a light outgoing surface of the display panel, images of a same scene at the light outgoing surface side of the display panel so as to obtain at least two preview images; specifically, the at least two image collectors in a mobile terminal may be used to acquire the images of a same scene to obtain at least two preview images; synthesizing the acquired at least two preview images into a target image such that a sharpness of the target image is higher than a sharpness of each of the preview images; specifically, the processor in the mobile terminal may be used to synthesize the at least two preview images acquired into the target image.

Optionally, the step of synthesizing the acquired at least two preview images into the target image includes: comparing, by the comparison element, intensities of high-frequency components for the sub-pixels of all the preview images at the respective same coordinate positions in order to obtain the sub-pixels, each of which has the maximum intensity of high-frequency component at a corresponding coordinate position, as target sub-pixels; and synthesizing the target sub-pixels by the synthesizer to obtain the target image; a sharpness of the target image is larger than that of each of the preview images.

The target image is sent by the controller to the display panel for display.

In a case that there are two image collectors, i.e., a first and a second image collectors, the imaging method in the present embodiment is described with reference to FIGS. 3 and 4.

When the first image collector and the second image collector acquire images for a same scene simultaneously, the image acquired by the first image collector refers to the first preview image, and the image acquired by the second image collector refers to the second preview image, the first and the second preview images have the same contents but different sharpness.

The comparison element compares the intensity of high-frequency component for each sub-pixel in the first preview image with that for the sub-pixel in the second preview image at the same coordinate position, and use the sub-pixel having the maximum intensity of high-frequency component as a target sub-pixel. For instance, the sub-pixel R11 stands for that located in the first row and the first column in the first preview image, and the sub-pixel R12 stands for that located in the first row and the first column in the second preview image. Then, the intensity of high-frequency component for the sub-pixel R11 is compared with that for the sub-pixel R12. If the former is larger than the latter, the sub-pixel R11 is taken as the target sub-pixel R13; on the contrary, if the former is smaller than the latter, the sub-pixel R12 is taken as the target sub-pixel R13. In the same way, other target sub-pixels in the target image are also obtained. At last, all the target sub-pixels are synthesized by the synthesizer to obtain the target image, and a sharpness of the target image is higher than that of each of the preview images.

The acquired target image is displayed by the display panel under the controlling of the controller.

In a case that there are more than two image collectors, the above method may also be used. That is, the comparison element compares the intensity of high-frequency component for each sub-pixel in each preview image with those for the sub-pixels in other preview images at the same coordinate position, respectively, and use the sub-pixel having the maximum intensity of high-frequency component as a target sub-pixel. At last, all the target sub-pixels are synthesized by the synthesizer to obtain the target image, and a sharpness of the target image is higher than that of any of the preview images.

In the case that there are two image collectors, the distance therebetween is less than 20 mm so that the two image collectors are guaranteed to acquire the same images (herein, the expression of “the same images” means the contents are same, does not mean the same sharpness), and thus obtaining a clearer target image.

According the imaging method of the mobile terminal in the present embodiment, the display area of the display panel is provided therein with at least two image collectors capable of acquiring the images for the same scene, and the processor synthesizes the at least two preview images acquired by the image collectors into the target image with a sharpness higher than that of each of the preview images. Therefore, the imaging method of the mobile terminal in the present embodiment can obtain a clearer image displayed on the display panel. Furthermore, since the image collectors of the mobile terminal in the present disclosure are provided at the side distal to the light-outgoing surface of the display panel, the mobile terminal can achieve the bezel-less design.

The flow chart and the block diagrams in the drawings illustrate the architecture, functionality, and operations of the possible implementations of the mobile terminal and the imaging method thereof in accordance with various embodiments of the present disclosure. In this regard, each block in the flow chart or the block diagrams can represent an element, a program segment, or a portion of codes which includes at least one executable instruction for implementing the specified logic functions. It should also be noted that, in some alternative implementations, the functions noted in the blocks may also occur in a different order than those illustrated in the drawings. For example, two blocks shown in succession sequentially may in fact be executed substantially in parallel, and they may sometimes be executed in the reverse order, depending upon the functionality involved. It is also noted that each block of the block diagrams and/or the flow chart, and the combinations thereof can be implemented by a hardware-based dedicated system that performs the specified functions or operations, or can be implemented by a combination of dedicated hardware and computer instructions.

The components or elements involved in the embodiments of the present disclosure may be implemented by software or by hardware. The described components or elements may also be provided in the processor. For example, each of the components may be a software program disposed in a computer or a mobile smart device, or may be a separately configured hardware device. The names of these components or elements are not to be construed as limitations on the components or elements themselves in some cases.

It will be appreciated that the above implementations are only exemplary implementations for illustrating the principle of the present disclosure. However, the present disclosure is not limited thereto. An ordinary person skilled in the art can make various modifications and improvements to the present disclosure without departing from the essence of the present disclosure. These modifications and improvements should be also considered to be within the scope of the present disclosure.

1. A mobile terminal, comprising a display panel, a processor, a controller and at least two image collectors located at a side of the display panel distal to a light outgoing surface of the display panel; wherein,
the at least two image collectors are configured to acquire images of a same scene at a side of the light outgoing surface of the display panel, respectively, so as to obtain at least two preview images;
the processor is configured to synthesize the acquired at least two preview images into a target image such that a sharpness of the target image is higher than a sharpness of at least one of the at least two preview images; and
the controller is configured to send the target image to the display panel for display.

2. The mobile terminal of claim 1, wherein the processor comprises a comparer and a synthesizer;
the comparer is configured to compare intensities of high-frequency components for sub-pixels of the at least two preview images at respective same coordinate positions, and use sub-pixels, each of which has maximum intensity of high-frequency component at a corresponding coordinate position, as target sub-pixels; and
the synthesizer is configured to synthesize the target sub-pixels to obtain the target image.

3. The mobile terminal of claim 1, wherein the mobile terminal comprises two image collectors.

4. The mobile terminal of claim 1, wherein the at least two image collectors acquire images simultaneously.

5. The mobile terminal of claim 3, wherein a distance between the two image collectors is less than 20 mm.

6. The mobile terminal of claim 1, wherein each of the at least two image collectors comprises a camera.

7. The mobile terminal of claim 1, wherein the at least two image collectors are located in a peripheral area in a display area of the display panel.

8. The mobile terminal of claim 1, wherein the mobile terminal comprises any one of a mobile phone, a pad, and an electronic reader.

9. An imaging method of the mobile terminal of claim 1, comprising:
acquiring, by the at least two image collectors at the side of the display panel distal to the light outgoing surface of the display panel, images of a same scene at the side of the light outgoing surface of the display panel so as to obtain at least two preview images;
synthesizing the acquired at least two preview images into a target image such that a sharpness of the target image is higher than a sharpness of each of the at least two preview images; and
sending the target image to the display panel for display.

10. The imaging method of the mobile terminal of claim 9, wherein the step of synthesizing the acquired at least two preview images into the target image comprises:
comparing intensities of high-frequency components for sub-pixels of the at least two preview images at respective same coordinate positions, and using sub-pixels, each of which has maximum intensity of high-frequency component at a corresponding coordinate position, as target sub-pixels; and
synthesizing the target sub-pixels to obtain the target image.

11. The imaging method of the mobile terminal of claim 9, wherein the at least two image collectors acquire images simultaneously.

12. The mobile terminal of claim 1, wherein the sharpness of the target image is higher than a sharpness of each of the at least two preview images.
